(19) United States
(12) Patent Application Publication
(10) Pub. No.: US 2006/0077351 A1
(43) Pub. Date: Apr. 13, 2006

(54) Image displaying apparatus and control method thereof

(75) Inventors: Tae-je Park, Suwon-si (KR); Won-sik Jeong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/205,111

(22) Filed: Aug. 17, 2005

(30) Foreign Application Priority Data
Oct. 11, 2004 (KR) 2004-81066

(51) Int. Cl. G03B 21/00; H04N 9/12

(52) U.S. Cl. 353/31; 348/743

(57) ABSTRACT

An image displaying apparatus including a display unit and an image outputting unit outputting an image to the display unit. The image displaying apparatus comprises a sync signal outputting unit processing an input signal and outputting a first sync signal, an internal sync signal generating unit generating a second sync signal and outputting it, a switching unit selectively outputting any one of the first sync signal and the second sync signal to the image outputting unit, and a control unit including a storage unit storing therein frequency information based on kinds of input signals which can externally be inputted, controlling the internal sync signal generating unit and the switching unit to thereby output the second sync signal according to a frequency of a switched input signal to the image outputting unit based on the stored frequency information, when the input signal is switched by a user.

### CROSS-REFERENCE TO RELATED APPLICATIONS

This invention is based on and claims priority from Korean Patent Application No. 2004-0081066, filed on Oct. 11, 2004 in the Korean Intellectual Property Office, the disclosure of which is incorporated herein in its entirety by reference.

### BACKGROUND OF INVENTION

1. Field of Invention

The present invention relates to an image displaying apparatus and a control method thereof, and more particularly, to an image displaying apparatus and control method thereof capable of reducing a time consumed in switching an input signal by performing simultaneously an operation of processing the switched input signal and an operation of stabilizing a color wheel when the input signal is switched.

2. Description of the Related Art

Generally projectors are widely used for presentation in business. As distribution of projectors has recently increased sharply, several types of projector products have been developed. These projectors are all treading toward being compact, light and slim to enhance the portability thereof.

As one of the display devices currently used for these projectors, a digital micromirror device (hereinafter referred to as “DMD”) is in wide use. The DMD is a light switch display device switching an angle of reflection of light into several modes by changing an angle of inclination of the micromirror. This DMD is used in a digital light processing (hereinafter referred to as “DLP”) engine.

Referring to FIG. 1, an image displaying apparatus employing the DLP engine described above comprises a light source (not shown) generating light based on an image signal from processing an input signal inputted from an input source 5, a color wheel 56 to transmit light in a specific wavelength band, an integrator (not shown) to make distribution of the light transmitted via the color wheel 56 uniform, a DMD 53 to reflect or otherwise transmit the light having passed the integrator (not shown) to a specific direction, a display unit 55 on which an image is displayed image through a transmission lens (not shown) according to the total reflection of the incident light on the DM1 53, and other devices.

A driving speed of the color wheel 56 is changed as a frequency of a vertical sync (V-Sync) signal of an input signal is changed. In other words, the driving speed of the color wheel 56 at the 50 Hz frequency of the input signal is different from that at the 60 Hz frequency of the input signal. When the frequency of the V-Sync signal is changed as the input signal has been switched, a state of transitional flickering is generated due to a driving instability until the color wheel 56 is stabilized to a driving speed according to the frequency of the switched V-Sync signal. This transitional flickering generally takes approximately 2.5 seconds until the color wheel 56 is stabilized according to the frequency of the switched V-Sync signal.

In this regard, in the conventional image displaying apparatus, when a first input source 1 is selected by a selection unit 7 while an image signal is received from a second input source 2, a microcomputer 15 controls a signal processing unit (not shown) including a sync signal outputting unit 10 and processes an input signal inputted from the switched first input source 1. At this time, it generally takes about 0.8 to 3 seconds to determine a frequency of the V-Sync signal of the input signal inputted from the switched first input source 1. Where the frequency of the V-Sync signal of the switched first input source 1 is different from the frequency of a V-Sync signal of a former input source that is the second input source 2, it further takes about 2.5 seconds until the color wheel 56 is stabilized as described above.

Therefore, when an input source is switched in the conventional image displaying apparatus, the transitional time for approximately 5.5 seconds at maximum is consumed to determine a frequency of a switched input signal and stabilize a color wheel according to a frequency of the changed V-Sync signal to thereby display a regular image.

### SUMMARY OF THE INVENTION

Accordingly it is an aspect of the present invention to provide an image displaying apparatus capable of reducing a time consumed in switching an input signal by performing simultaneously an operation of processing the switched input and an operation of stabilizing a color wheel when the input signal is switched.

The foregoing and/or other aspects of the present invention are also achieved by providing an image displaying apparatus including a display unit and an image outputting unit outputting an image to the display unit, comprising a sync signal outputting unit processing an input signal and outputting a first sync signal; an internal sync signal generating unit generating a second sync signal and outputting it; a switching unit selectively outputting any one of the first sync signal and the second sync signal to the image outputting unit; and a control unit including a storage unit storing therein frequency information by kinds of input signals which can externally be inputted, controlling the internal sync signal generating unit and the switching unit to thereby output the second sync signal according to a frequency of a switched input signal to the image outputting unit based on the stored frequency information, when the input signal is switched by a user.

According to an exemplary embodiment of the present invention, when the first sync signal according to the switched input signal is outputted from the sync signal outputting unit while the second sync signal according to the frequency of the input signal switched based on the frequency information is being outputted to the image outputting unit, the control unit controls the switching unit to output the first sync signal to the image outputting unit.

According to another exemplary embodiment of the present invention, the control unit determines whether frequencies of the second sync signal according to the switched input signal and the first sync signal according to the switched input signal are identical, and, when they are not identical, updates the frequency of the first sync signal according to the switched input signal to the frequency information of the switched input signal and stores it in the storage unit.

According to yet another exemplary embodiment of the present invention, when the frequencies of the second sync signal according to the switched input signal and the first sync signal according to the switched input signal are not identical, the control unit controls the internal sync signal generating unit and the switching unit to output the second sync signal according to the updated frequency to the image outputting unit and, after a predetermined time has elapsed, it controls the switching unit to thereby output the first sync signal to the image outputting unit.

According to yet another exemplary embodiment of the present invention, the control unit comprises a program, which is included in a microcomputer controlling an image displaying function of the image displaying apparatus.

According to yet another exemplary embodiment of the present invention, the image outputting unit comprises a color wheel driven at different rotation speeds depending upon the frequency of the inputted sync signal.

The foregoing and/or other aspects of the present invention are also achieved by providing a control method of an image displaying apparatus comprising a display unit, a sync signal generating unit processing an input signal and outputting a first sync signal and an image outputting unit having a color wheel driven at different rotation speeds depending upon a frequency of an inputted sync signal, outputting an image to the display unit, comprising: storing frequency information by kinds of input signals which can externally be inputted; sensing whether the input signal is switched; internally generating a second sync signal according to the frequency of a switched input signal based on the frequency information and outputting it, when the input signal is switched; and switching the second sync signal so as to be outputted to the image outputting unit.

According to yet another exemplary embodiment of the present invention, the control method further comprising: processing the switched input signal, at the sync signal outputting unit; sensing whether the sync signal outputting unit has processed the switched input signal and the first sync signal has been outputted accordingly; and switching the first sync signal to be outputted to the image outputting unit, when the first sync signal according to the switched input signal is outputted.

According to yet another exemplary embodiment of the present invention, the switching comprises determining whether frequencies of the second sync signal according to the switched input signal and the first sync signal according to the switched input signal are identical, when the first sync signal according to the switched input signal is outputted; and updating the frequency of the first sync signal according to the switched input signal to the frequency information of the switched input signal and storing it, where the frequencies of the second input signal and the first input signal are not identical.

According to yet another exemplary embodiment of the present invention, the control method further comprising: processing the switched input signal, at the sync signal outputting unit; sensing whether the sync signal outputting unit has processed the switched input signal and the first sync signal has been outputted accordingly; determining whether frequencies of the second sync signal according to the switched input signal and the first sync signal according to the switched input signal are identical; updating the frequency of the first sync signal according to the switched input signal to the frequency information of the switched input signal, where the frequencies of the second input signal and the first input signal are not identical, when the first sync signal according to the switched input signal is outputted; outputting the second sync signal according to the updated frequency; and switching the first sync signal to be outputted to the image outputting unit after a predetermined time has elapsed.

### BRIEF DESCRIPTION OF THE DRAWINGS

The above and other objects and features of the present invention will become apparent from the following description of exemplary embodiments given in conjunction with the accompanying drawings, in which:

FIG. 1 is a control block diagram illustrating a sync signal output control of a conventional image displaying apparatus;

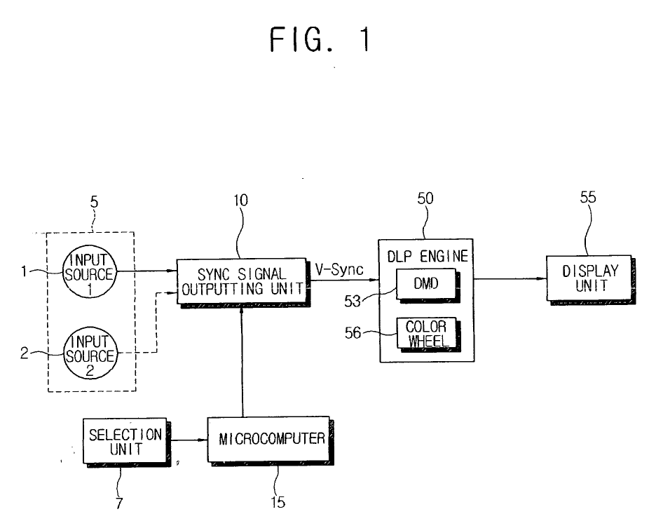

FIG. 2 is a control block diagram illustrating a sync signal output control of an image displaying apparatus according to an exemplary embodiment of the present invention; and

FIG. 3 is a control flow chart illustrating a control of the image displaying apparatus according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

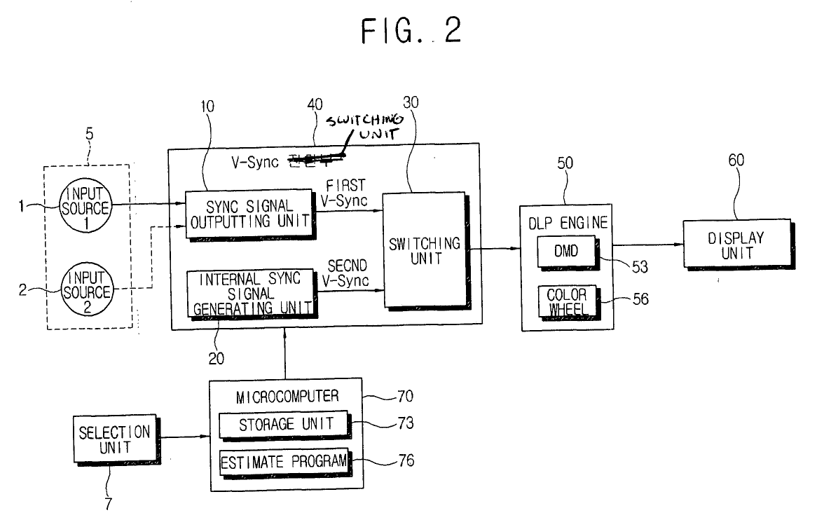

FIG. 2 is a control block diagram illustrating a sync signal output control of an image displaying apparatus according to the present invention. The image displaying apparatus comprises a display unit 60, various input sources 5, a selection unit 7 to allow a user to manipulate an image displaying function, a V-Sync switching unit 40 to selectively output any one of a first V-sync signal generated by processing an input signal from any one of various input sources 5 and a second V-sync signal internally generated and outputted, a digital light processing (DLP) engine 50 including a color wheel 56 to transmit light in a specific wavelength band from a light source (not shown) and a DMD 53 to reflect or transmit the light to a specific direction, outputting an image to the display unit 60, and a microcomputer 70 including a storage unit 73 storing therein frequency information by types of input signals which can be externally inputted and an estimate program 76 to control the V-Sync switching unit 40 based on the frequency information.

Details of the DLP engine will not be described because it is of the same as in the conventional image displaying apparatus but the same reference numerals will be used.

Various input sources 5 are sources which output input signals in the form inputable into the image displaying apparatus according to the present invention. The various input sources 5 include a base station (not shown) supplying a radio frequency (RF) broadcast signal, a video source (not shown) supplying an S-Video signal, a DVD player (not shown) supplying a DVD image and sound signals, an AV device (not shown) supplying audio and video (A/V) signals and so on. For the sake of convenience, the present invention will be described with respect to two input sources (first and second input sources 1 and 2 respectively) by way of example, wherein input signals from the first and the second input signals 1 and 2 output V-Sync signals having different frequencies.

The V-Sync switching unit 40 comprises a sync signal outputting unit 10 processing an input signal inputted from either of the first input source 1 or the second input source 2 and outputting the first V-Sync signal, an internal sync signal generating unit 20 internally generating the second V-Sync signal and outputting it, and a switching unit 30 selectively outputting to the color wheel 56 of the DLP engine 50 one of the first V-Sync signal and the second V-Sync signal.

The sync signal outputting unit 10 has the same construction as the conventional image displaying apparatus; that is, it processes the input signal inputted from either the first input source 1 or the second input source 2 and outputs the first V-Sync signal generated accordingly.

The internal sync signal generating unit 20 internally generates the second V-Sync signal according to control by an estimate program 76 of a microcomputer 70 to be described later and outputs the generated second V-Sync signal.

The microcomputer 70 comprises a storage unit 73 storing therein frequency information of respective input signals available for external input, namely input signals outputted from the first input source 1 and the second input source 2. The storage unit 73 stores therein frequency information obtained from the respective input signals at an initial time as the input sources (first or second input sources) are connected to the image displaying apparatus since input signals of identical frequencies are generally inputted from identical input sources. For example, if an input source 5 comprises a base station (not shown) supplying an RF broadcast signal, it is possible that the microcomputer 70 carries out an automatic search process and stores frequency information of respective channels of the RF broadcast in the storage unit 73.

When the microcomputer 70 determines that an input source is switched due to a manipulation through the selection unit 7, for example, when the first input source 1 is selected while it is processing an input signal from the second input source 2, the microcomputer 70 controls the signal processing unit (not shown) including a sync signal outputting unit 10 to thereby process the input signal inputted from the first input source 1. At the same time the microcomputer 70 controls the internal sync signal generating unit 20 and the switching unit 30 based on the frequency information stored in the storage unit 70 through the estimate program 76.

When the first input source 1 is selected while an input signal from the second input source 2 is in process, the estimate program 76 controls the internal sync signal generating unit 20 to thereby output the second V-Sync signal of the frequency according to the input signal from the first input source 1 based on the frequency information of the storage unit 70. At this time, the estimate program 76 controls the switching unit 30 so that an output path from the sync signal outputting unit 10 is intercepted and the second V-Sync signal outputted from the internal sync signal generating unit 20 is outputted to the DLP engine 50.

At this time, the signal processing unit (not shown) including the sync signal outputting unit 10 performs an operation of determining and processing an input signal inputted from the first input source 1 according to the control by the microcomputer 70, as in the conventional image displaying apparatus.

Where the first V-Sync signal according to an input signal from the first input source 1 is outputted from the sync signal outputting unit 10 having completed an input signal processing operation while the second V-Sync signal of the frequency according to an input signal from the first input signal 1 is being outputted to the DLP engine 50, the estimate program 76 determines whether the second V-Sync signal and the first V-Sync signal are identical, based on the frequency information stored in the storage unit 73.

When it is determined that the second V-Sync signal and the first V-Sync signal are identical, the estimate program 76 controls the switching unit 30 to thereby output the first V-Sync signal to the DLP engine 50. Here, if the second V-Sync signal and the first V-Sync signal are identical, switching the second V-Sync signal to the first V-Sync signal and then outputting it to the DLP engine would not substantially influence any change in the driving speed of the color wheel 56.

Accordingly, the image displaying apparatus according to the present invention determines and processes a frequency of a V-Sync signal of an input signal inputted from the first switched input source 1, and outputs the first V-Sync signal of the input signal inputted from the first input source 1 from the sync signal outputting unit 10, and simultaneously stabilizes the driving speed of the color wheel 56 by internally outputting the second V-Sync signal to the DLP engine 50 according to the stored frequency information of the first input source 1 selected to be switched. Then, if the first V-Sync signal according to the input signal inputted from the first input source 1 is outputted from the sync signal outputting unit 10, the image displaying apparatus switches the second V-Sync signal being outputted to the DLP engine to the first V-Sync signal.

When it is determined that the second V-Sync signal and the first V-Sync signal are not identical as a result of comparing them, the estimate program 76 updates the frequency of the first V-Sync signal to the frequency information of the first input source and stores it in the storage unit 73. The estimate program 76 controls the internal sync signal processing unit 20 to thereby output the second V-Sync signal according to the updated frequency to the DLP engine 50 and, after the predetermined time has elapsed, controls the switching unit 30 to thereby output the first V-Sync signal, according to an input signal inputted from the first input source 1, to the DLP engine 50. The predetermined time preferably refers to the time consumed until the driving speed of the color wheel 56 is stabilized by the second V-Sync signal according to the updated frequency.

An exemplary embodiment described above illustrates that the storage unit 73 and the estimate program 76 are structurally included in the microcomputer 70 by way of example. However, they do not have to be included in the microcomputer 70, but may be provided separately from the microcomputer 70.

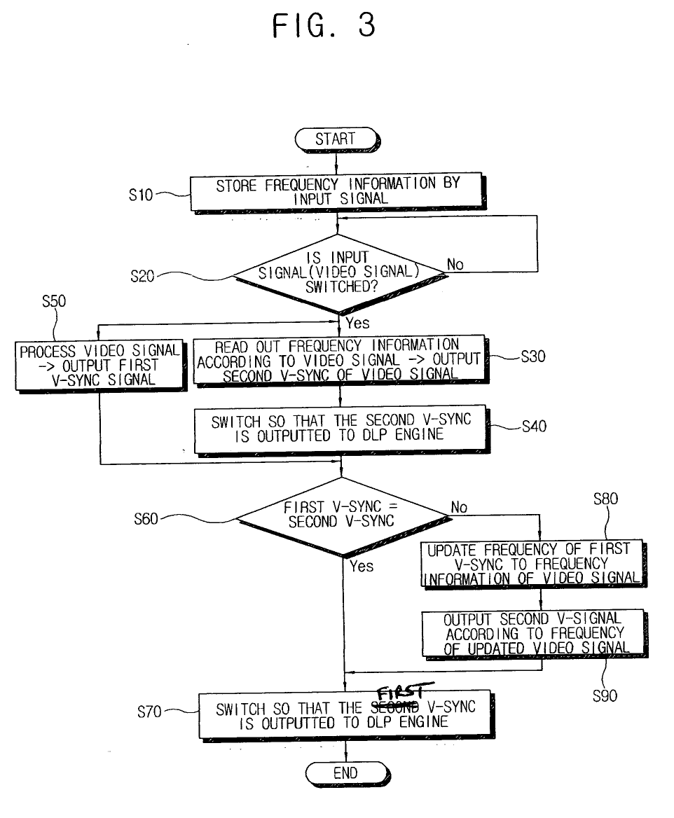

Referring to FIG. 3, a control flow of the image displaying apparatus according to an exemplary embodiment of the present invention will be described. Sync signal frequency information of input signals by input sources connected to the image displaying apparatus is first stored in the storage unit 73 at operation S10. The microcomputer 70 senses whether the input source has been selected to switch through the selection unit 7 at operation S20. If the input source is selected to switch (for example, from the second input source 2 to the first input source 1 (a video signal)), the estimate program 76 reads out frequency information according to the video signal based on the frequency information stored in the storage unit 73 and accordingly controls the internal sync signal generating unit 20 to thereby output the second V-Sync signal at operation S30. Here, the estimate program 76 controls the switching unit 30 to thereby output the second V-Sync signal to the DLP engine 50 S40. Passing through operations S30 and S40, the driving speed of the color wheel 56 is stabilized adaptively to the switched video signal. While the estimate program 76 is performing operations S30 and S40, the microcomputer 70 simultaneously performs a process of processing the switched video signal and outputting the first V-Sync signal as in the conventional art at operation S50. When the first V-Sync signal is outputted from the switched video signal processed, the estimate program 76 further compares it with the second V-Sync signal and determines whether they are identical at operation S60. Where they are identical, the estimate program 76 controls the switching unit 30 to thereby output the first V-Sync signal to the DLP engine 50 at operation S70.

Since operation S50 of identifying a frequency of V-Sync signal of the switched video signal and accordingly outputting the first V-Sync signal can be performed simultaneously with operations S30 and S40 of stabilizing the driving speed of the color wheel 56 adaptive to the switched video signal, the time consumed in switching may be shortened when an input source is switched.

When it is determined that the second V-Sync signal and the first V-Sync signal are not identical in operation S60, the estimate program 76 updates the frequency of the first V-Sync signal to the frequency information of the video signal and stores it in the storage unit 73 at operation S80. The estimate program 76 controls the internal sync signal generating unit 20 to thereby output the second V-Sync signal according to the updated frequency information to the DLP engine 50 at operation S90. Thereafter, the estimate program 76 controls the switching unit 30 to thereby output the first V-Sync signal to the DLP engine 50 when the driving speed of the color wheel 56 is stabilized adaptively to the updated frequency information at operation S70.

However, input sources 5 inputable into the image displaying apparatus are generally limited. Operations S80 and S90 are identical to a process of obtaining frequency information from respective input signals at an initial time when input sources 5 are connected to the image displaying apparatus. Thus, once the frequency information of the input sources 5 is stored, operations S80 and S90 would not occur except for reconnection of the input sources 5 to the image displaying apparatus when any of existing input sources 5 is specially replaced with a new one by a user.

As described above, when an input signal is switched, the image displaying apparatus according to an exemplary embodiment of the present invention simultaneously outputs the second V-Sync signal estimated according to the stored frequency information during the processing time (approximately 0.8 to 3 seconds) to determine a frequency of the switched input signal and output the first V-Sync signal, and switches the second V-Sync signal into the first V-Sync signal when the first V-Sync signal is outputted from the switched input signal processed after driving of the color wheel 56 has been stabilized (approximately 2.5 seconds).

According to this, since a frequency determination of an input signal and a stabilization of the color wheel 56 according to the frequency of the changed V-Sync signal are performed simultaneously when the input source is switched, there is an effect of shortening the time consumed for switching until a regular image is displayed.

As described above, an exemplary embodiment of the present invention provides an image displaying apparatus capable of reducing a time consumed in switching an input signal by performing simultaneously an operation of processing the switched input signal and an operation of stabilizing a color wheel when the input signal is switched.

Although exemplary embodiments of the present invention has been described in connection with the exemplary embodiments illustrated in the accompanying drawings, it should be understood that the present invention is not limited thereto and those skilled in the art can make various modifications and changes without departing from the scope of the invention.

What is claimed is:

1. An image displaying apparatus including a display unit and an image outputting unit outputting an image to the display unit, comprising:
a sync signal outputting unit processing an input signal and outputting a first sync signal;
an internal sync signal generating unit generating a second sync signal and outputting the second sync signal;
a switching unit selectively outputting one of the first sync signal and the second sync signal to the image outputting unit; and
a control unit including a storage unit storing therein frequency information based on kinds of input signals which can externally be inputted, controlling the internal sync signal generating unit and the switching unit to thereby output the second sync signal according to a frequency of a switched input signal to the image outputting unit based on the stored frequency information, if the input signal is switched by a user.

2. The apparatus as claimed in claim 1, wherein, if the first sync signal according to the switched input signal is outputted from the sync signal outputting unit while the second sync signal according to the frequency of the input signal switched based on the frequency information is being outputted to the image outputting unit, the control unit controls the switching unit to output the first sync signal to the image outputting unit.

3. The apparatus as claimed in claim 2, wherein the control unit determines whether frequencies of the second sync signal according to the switched input signal and the first sync signal according to the switched input signal are identical, and, if they are not identical, updates the frequency of the first sync signal according to the switched input signal to the frequency information of the switched input signal and stores it in the storage unit.

4. The apparatus as claimed in claim 3, wherein, if the frequencies of the second sync signal according to the switched input signal and the first sync signal according to the switched input signal are not identical, the control unit controls the internal sync signal generating unit and the switching unit to output the second sync signal according to the updated frequency to the image outputting unit and, after a predetermined time has elapsed, the control unit controls the switching unit to thereby output the first sync signal to the image outputting unit.

5. The apparatus as claimed in claim 4, wherein the control unit comprises a program, which is included in a microcomputer controlling an image displaying function of the image displaying apparatus.

6. The apparatus as claimed in claim 1, wherein the image outputting unit comprises a color wheel driven at different rotation speeds depending upon the frequency of an inputted sync signal.

7. A control method of an image displaying apparatus comprising a display unit, a sync signal generating unit processing an input signal and outputting a first sync signal and an image outputting unit having a color wheel driven at different rotation speeds depending upon a frequency of an inputted sync signal, and outputting an image to the display unit, said method comprising:
storing frequency information based on kinds of input signals which can externally be inputted;
sensing whether the input signal is switched;
internally generating a second sync signal according to the frequency of a switched input signal based on the frequency information and outputting the second sync signal, when the input signal is switched; and
switching the second sync signal so as to be outputted to the image outputting unit.

8. The control method as claimed in claim 7, further comprising:
processing the switched input signal, at the sync signal outputting unit;
sensing whether the sync signal outputting unit has processed the switched input signal and the first sync signal has been outputted accordingly; and
switching the first sync signal to be outputted to the image outputting unit, if the first sync signal according to the switched input signal is outputted.

9. The control method as claimed in claim 8, wherein the switching comprises:
determining whether frequencies of the second sync signal according to the switched input signal and the first sync signal according to the switched input signal are identical, if the first sync signal according to the switched input signal is outputted; and
updating the frequency of the first sync signal according to the switched input signal to the frequency information of the switched input signal and storing the updated frequency of the first sync signal, where the frequencies of the second input signal and the first input signal are not identical.

10. The control method as claimed in claim 7, further comprising:
processing the switched input signal, at the sync signal outputting unit;
sensing whether the sync signal outputting unit has processed the switched input signal and the first sync signal has been outputted accordingly;
determining whether frequencies of the second sync signal according to the switched input signal and the first sync signal according to the switched input signal are identical;
updating the frequency of the first sync signal according to the switched input signal based on the frequency information of the switched input signal, where the frequencies of the second input signal and the first input signal are not identical, if the first sync signal according to the switched input signal is outputted;
outputting the second sync signal according to the updated frequency; and
switching the first sync signal to be outputted to the image outputting unit after a predetermined time has elapsed.
